(19) United States
(12) Patent Application Publication
(10) Pub. No.: US 2006/0014495 A1
(43) Pub. Date: Jan. 19, 2006

(54) Wireless communication system

(76) Inventor: Masashi Oshima, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/010,695

(22) Filed: Nov. 19, 2004

(30) Foreign Application Priority Data
Jul. 16, 2004 (JP) 2004-210676

(51) Int. Cl. H04B 15/00

(52) U.S. Cl. 455/63.1; 455/114.2

(57) ABSTRACT

A wireless communication system that can perform transmission current control of a handset in accordance with a radio wave situation. The wireless communication system includes a base phone and a handset, in which the base phone includes an RSSI detection section for detecting the RSSI of a carrier wave and the RSSI of an interference wave that are sent from the handset, and a control section for sending a transmission current control command to the handset on the basis of the Cl ratio obtained from the ratio between the RSSI of the carrier wave and the RSSI of the interference wave.

### BACKGROUND

The present invention relates to a wireless communication system that comprises a base phone and a handset, and particularly to an improvement technology for controlling a transmission current of the handset by predicting errors from the level of an interference wave.

A wireless access method between a handset (or a mobile station) and a base phone (or a base station) in the second generation cordless telephone system employs a 4-channel multiplex TDMA-TDD multicarrier scheme for sharing a single frequency by dividing it in terms of time, to send and receive voice data and control signals alternately in the up-line direction from the handset to the base phone and in the down-line direction from the base phone to the handset. In Second Generation Cordless Telephone System Standard RCR STD-28, when performing carrier sense, the level of an interference wave of a slot to be used and the levels of the interference wave before and after the slot are measured for four or more frames before requesting a call, and if the result is no more than a prescribed level, the slot to be used is determined as an empty slot.

### SUMMARY

Since the handset of the wireless communication system is operated by a built-in battery, it is preferred not to increase the transmission power regardless of the situation of the radio wave, in terms of electrical power consumption. In a radio wave situation where less interference waves exist, a good wireless communication is possible even if the transmission power is reduced. Thus it is preferred that transmission current control of the handset be performed in accordance with the radio wave situation.

The present invention resolves such problem, and provides a wireless communication system in which transmission current control of a handset can be performed in accordance with a radio wave situation.

The present invention in one aspect relates to a wireless communication system that includes a base phone and a handset, where the base phone includes an RSSI detection section for detecting an RSSI of a carrier wave and an RSSI of an interference wave that are sent from the handset, and a control section for sending a transmission current control command to the handset on the basis of the Cl (carrier to interference) ratio obtained from the RSSI of the carrier wave and the RSSI of the interference wave. Greater transmission current control is possible by predicting generation of data errors on the basis of the Cl ratio and utilizing the prediction in the transmission current control of the handset.

The wireless communication system of the present invention performs wireless communication between a base phone and a handset by means of a time division multiplexing access scheme where a transmission slot and a reception slot are repeated at predetermined intervals. In this wireless communication system, the base phone includes an RSSI detection section for detecting the RSSI of a carrier wave sent from the handset at the timing of the reception slot, and for detecting the RSSI of an interference wave at the timing of a guard time, and a control section for sending a transmission current control command to the handset on the basis of the Cl ratio obtained from the RSSI of the carrier wave and the RSSI of the interference wave. In the wireless communication system that employs the time division multiplexing access scheme, the RSSI of the carrier wave can be detected at the timing of the reception slot, and the RSSI of the interference wave can be detected at the timing of the guard time.

It is desirable that the control section of the base phone send the transmission current control command to the handset on the basis of an average value of the Cl ratio calculated by measuring the RSSI of the carrier wave and the RSSI of the interference wave more than once. By using the average value of the Cl ratio, the radio wave situation can be judged appropriately.

Moreover, it is desirable that the control section of the base phone calculate the average value of the Cl ratio based on the RSSI of the carrier wave detected more than once within a reception time of a packet, as well as on the RSSI of the interference wave detected more than once within a guard time period. Since the transmission current control command can be transmitted by the amount of data of a packet, by monitoring the radio wave situation every reception time of the packet, detailed transmission current control is possible.

The wireless communication system of the present invention may include a plurality of handsets, and any of the plurality of handsets may include an RSSI detection section for detecting the RSSI of a carrier wave and the RSSI of an interference wave that are sent from another handset, and a control section for sending a transmission current control command to the abovementioned another handset on the basis of the Cl ratio obtained from the RSSI of the carrier wave and the RSSI of the interference wave. Flexible system designing is possible by making a configuration where transmission current control can be performed not only for the base phone but also among the handsets.

Other aspects, features and embodiments of the invention will be more fully apparent from the ensuing disclosure and appended claims.

### DESCRIPTION OF DRAWINGS

FIG. 1 is a functional block diagram of a cordless telephone set according to one embodiment of the present invention;

FIG. 2 is a graph showing a relationship between the RSSI and received power;

FIG. 3 is an explanatory diagram of points of RSSI measurement; and

FIG. 4 is an explanatory diagram of the transmission current control of the present embodiment.

### DETAILED DESCRIPTION

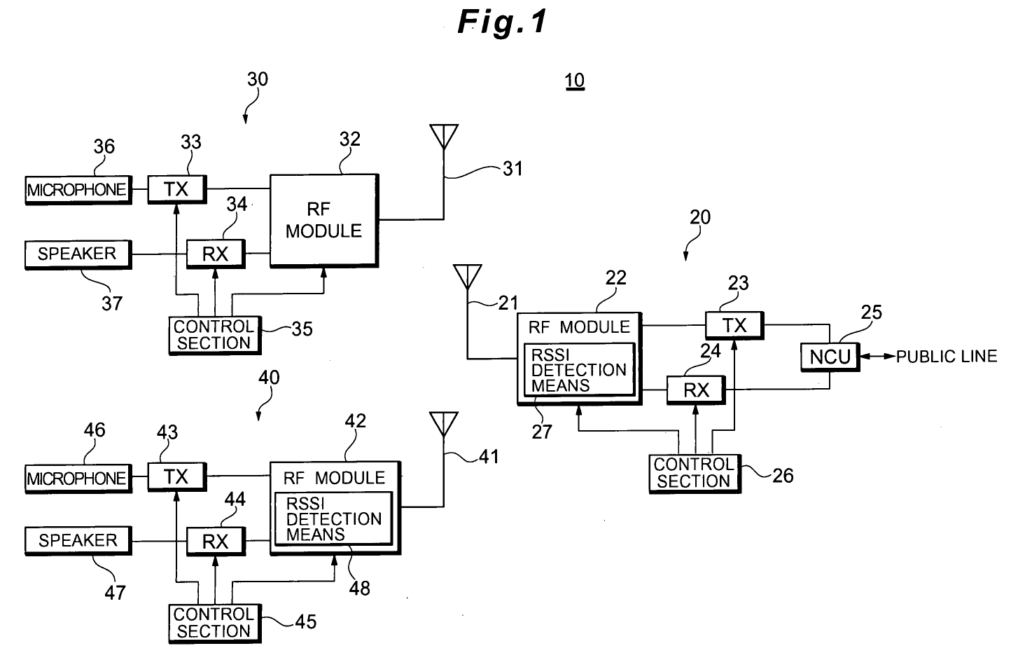

FIG. 1 shows a functional block diagram of a cordless telephone set 10 in accordance with one embodiment of the present invention. The cordless telephone set 10 comprises a base phone 20 and two handsets 30, 40. The base phone 20 is connected to the public line via a network control unit (NCU), performs, in a transmission processing section (TX) 23, amplification processing and the like on a voice signal sent from a public line, and thereafter modulates the voice signal in a radiofrequency (RF) module 22, and then sends it to the handsets 30, 40 via an antenna 21. After the base phone 20 receives a wireless radio wave sent from the handsets 30, 40 with the antenna 21, this received radio wave is demodulated in the RF module 22, is subjected to amplification processing and the like in a reception processing section (RX) 24, and is outputted to the network control unit 25. The RF module 22 comprises an RSSI (Received Signal Strength Indicator) detection section 27 for detecting an RSSI of a reception radio wave. A control section 26 controls the RF module 22, transmission processing section 23, and reception processing section 24. The control section 26 acquires an average value of the RSSI of the reception radio wave from the RSSI detection section 27 to calculate an average value of the Cl ratio, and sends a transmission current control command to the handsets 30, 40 on the basis of the average value of the Cl ratio. For example, when the average value of the Cl ratio is higher than a predetermined threshold, the radio wave situation is good, thus a control command to lower the transmission current is sent to the handsets 30, 40. On the other hand, when the average value of the Cl ratio is lower than the predetermined threshold, it is predicted that a data error will be generated if nothing is done, thus a control command to raise the transmission current is sent to the handsets 30, 40.

As with the base phone 20, the handset 30 also comprises a receiver section (microphone 36, speaker 37), in addition to an antenna 31, RF module 32, transmission processing section 33, reception processing section 34, and control section 35. The handset 40 also has the same configuration as the handset 30. Once the handsets 30, 40 receive the transmission current control command from the base phone 20, the handsets 30, 40 change a transmission power level to a power level that the base phone 20 has designated.

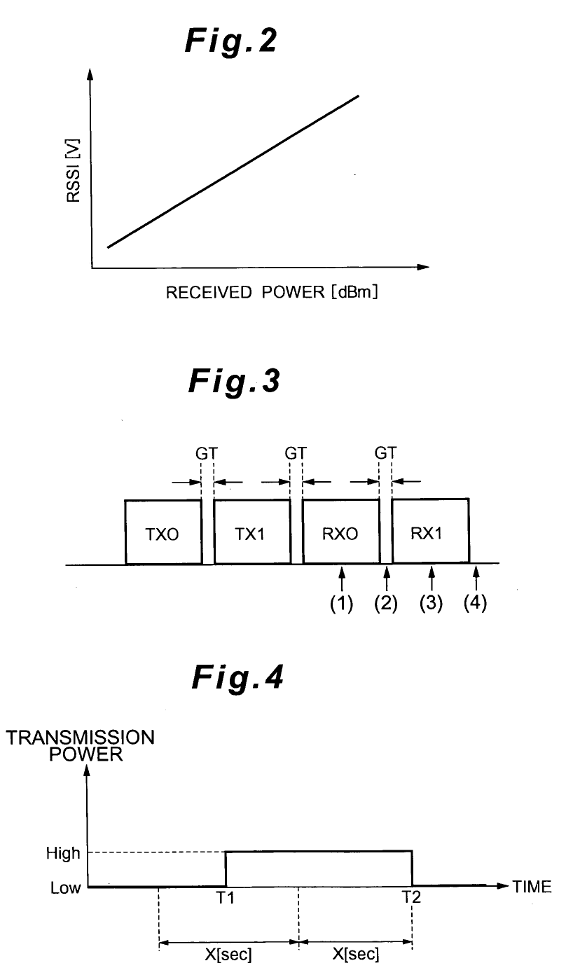

The data error is generated in the wireless communication when the Cl ratio becomes small and the data overlapped in the carrier wave is unable to be discriminated. Therefore, by measuring the received power of the carrier wave and the received power of the interference wave, it is possible to predict the data error generation. As shown in FIG. 2, there is a linear relationship between the received power (dBm) and RSSI (V). Therefore, by preparing map data as shown in the figure in advance, the received power can be obtained from the RSSI of the reception radio wave. In order to detect the RSSI of the carrier wave and the RSSI of the interference wave, it is necessary to set the measuring timing in the frame to an appropriate timing. FIG. 3 shows points of measurement of the RSSI in the frame when the base phone 20 performs time division multiplexing communication with the two handsets 30, 40. In the figure, TX0 denotes a transmission slot of the handset 30, TX1 denotes a transmission slot of the handset 40, RX0 denotes a reception slot of the handset 30, RX1 denotes a reception slot of the handset 40, and GT denotes the guard time. Also, (1) and (3) of the figure indicate the points of RSSI measurement in the reception slot intervals of the carrier wave, while (2) and (4) indicate the points of RSSI measurement in the guard time intervals of the interference wave. The Cl ratio can be obtained from the RSSI of the carrier wave detected at the points of measurement, (1) and (3), and from the RSSI of the interference wave detected at the points of measurement, (2) and (4).

The RSSI fluctuates by receiving significant effects such as phasing, a weak electric field, radio interference and the like, whereby variation in an RSSI value can be observed in accordance with a radio wave situation of the moment in which the RSSI is measured. In order to judge the radio wave situation accurately, it is necessary to calculate the average value of the Cl ratio based on the average value of the RSSI of the carrier wave and the average value of the RSSI of the interference wave that were detected more than once for a given length of time, so that the radio wave situation is judged on the basis of the average value of the Cl ratio. However, increasing the number of times for detecting the RSSI requires much time for the detection, thus there is a possibility that the transmission current control for the handsets 30, 40 cannot follow the changes of the radio wave situations. For the detection time of the RSSI, an appropriate amount of time is preferred where a radio wave situation can be judged appropriately and the changes of the radio wave situations can be followed. If data of a packet (27 ms of the transmission time) exists, the transmission current control command can be sent to the handsets 30, 40, whereby, for example, the detection time of the RSSI may be set to the reception time for the packet. By monitoring the radio wave situation for every single packet, detailed transmission current control is possible. The average value of the Cl ratio can be calculated based on the average value of the RSSI of the carrier wave that has been detected more than once within the reception time of the packet, and the average value of the RSSI of the interference wave that has been detected more than once within the guard time period.

As a specific means of the transmission current control, as shown in FIG. 4, it is preferred that whether the power level should be raised or not is judged every transmission of a packet, and that judging whether the power level should be lowered or not be performed at a time of X (seconds), which is longer enough than the transmission time of the packet. In other word, when judging whether or not the power level should be raised, a control command to raise the power level is sent to the handsets 30, 40 if the average value of the Cl ratio is higher than the predetermined threshold; and when judging whether or not the power level should be lowered, a control command to lower the power level is sent to the handsets 30, 40 if the average value of the Cl ratio has been lower than the predetermined threshold during the period of the time X. Here, it is detected at a time of T1 that the radio wave situation has deteriorated to send a control command to raise the transmission power from a low level to a high level. Moreover, it is detected at a time of T2 that the radio wave situation recovers to a good condition, and a control command is sent to lower the transmission power level from the high level to the low level. In such judgment of whether or not the power level should be lowered, by judging the power level, taking time longer enough than a transmission time of one packet, it is possible to perform appropriate transmission current control that corresponds to the fluctuations of the radio wave situation.

Note that, in above description, the configuration where the base phone 20 controls the transmission power of the handsets 30, 40 was exemplified; but the present invention is not limited to this arrangement, and, for example, it may be configured so that the transmission power is controlled between the handsets. As shown in FIG. 1, an RF module 42 of the handset 40 comprises an RSSI detection section 48 for detecting the RSSI of the reception radio wave, and the average value of the Cl ratio can be calculated as with the base phone 20. The handset 40 calculates the average value of the Cl ratio from the average value of the RSSI of the carrier wave and the average value of the RSSI of the interference wave that were sent from the handset 30, and sends the transmission current control command to the handset 30 on the basis of the average value of the Cl ratio.

According to the present embodiment, generation of data errors is predicted based on the average value of the Cl ratio to control the transmission power of the handsets 30, 40, so that it is possible to realize transmission current control of higher precision.

While the invention has been described herein with reference to illustrative features and embodiments, other variations, modifications and alternative embodiments of the invention will readily suggest themselves to those of ordinary skill in the art based on the disclosure herein, and therefore are to be regarded as being within the spirit and scope of the invention.

We claim:

1. A wireless communication system, comprising a base phone and a handset, wherein said base phone comprises:
an RSSI detection section for detecting the RSSI of a carrier wave and the RSSI of an interference wave that are sent from said handset; and
a control section which sends a transmission current control command to said handset on the basis of the Cl ratio obtained from said RSSI of the carrier wave and said RSSI of the interference wave.

2. A wireless communication system for performing wireless communication between a base phone and a handset by means of a time division multiplexing access scheme in which a transmission slot and a reception slot are repeated at predetermined time intervals, wherein said base phone comprises:
an RSSI detection section for detecting the RSSI of a carrier wave sent from said handset at the timing of the reception slot as well as for detecting the RSSI of an interference wave at the timing of a guard time; and
a control section for sending a transmission current control command to said handset on the basis of the Cl ratio obtained from said RSSI of the carrier wave and said RSSI of the interference wave.

3. The wireless communication system according to claim 1, wherein the control section of said base phone sends the transmission current control command to said handset on the basis of an average value of the Cl ratio, which is calculated by measuring said RSSI of the carrier wave and said RSSI of the interference wave more than once.

4. The wireless communication system according to claim 2, wherein the control section of said base phone sends the transmission current control command to said handset on the basis of an average value of the Cl ratio, which is calculated by measuring said RSSI of the carrier wave and said RSSI of the interference wave more than once.

5. The wireless communication system according to claim 3, wherein the control section of said base phone calculates the average value of the Cl ratio based on said RSSI of the carrier wave detected more than once within a reception time of a packet, as well as on said RSSI of the interference wave detected more than once within a guard time period.

6. The wireless communication system according to claim 4, wherein the control section of said base phone calculates the average value of the Cl ratio based on said RSSI of the carrier wave detected more than once within a reception time of a packet, as well as on said RSSI of the interference wave detected more than once within a guard time period.

7. The wireless communication system according to claim 1, comprising a plurality of handsets, wherein any of said plurality of handsets comprises:
an RSSI detection section for detecting the RSSI of a carrier wave and the RSSI of an interference wave that are sent from another handset; and
a control section for sending a transmission current control command to said another handset on the basis of the Cl ratio obtained from said RSSI of the carrier wave and said RSSI of the interference wave.

8. The wireless communication system according to claim 2, comprising a plurality of handsets, wherein any of said plurality of handsets comprises:
an RSSI detection section for detecting the RSSI of a carrier wave and the RSSI of an interference wave that are sent from another handset; and
a control section for sending a transmission current control command to said another handset on the basis of the Cl ratio obtained from said RSSI of the carrier wave and said RSSI of the interference wave.
